(19) United States
(12) Patent Application Publication
(10) Pub. No.: US 2013/0160986 A1
(43) Pub. Date: Jun. 27, 2013

(54) AIR CONDITIONER FOR VEHICLE

(71) Applicants: Hideki Hashigaya, Shizuoka (JP); Isamu Ito, Shizuoka (JP); Yorisada Kondo, Shizuoka (JP); Yuki Futsuhara, Shizuoka (JP)

(72) Inventors: Hideki Hashigaya, Shizuoka (JP); Isamu Ito, Shizuoka (JP); Yorisada Kondo, Shizuoka (JP); Yuki Futsuhara, Shizuoka (JP)

(73) Assignee: SUZUKI MOTOR CORPORATION, Hamamatsu-shi, Shizuoka (JP)

(21) Appl. No.: 13/700,927

(22) PCT Filed: Apr. 19, 2011
(86) PCT No.: PCT/JP2011/059632

§ 371 Date: Mar. 11, 2013

(30) Foreign Application Priority Data
May 31, 2010 (JP) 2010-123858

(51) Int. Cl. B60H 1/00

(52) U.S. Cl. CPC B60H 1/00764; B60H 1/00885
USPC 165/202; 62/215

(57) ABSTRACT

An air conditioner for a vehicle equipped with a motor for driving the vehicle has a vehicle speed detecting unit, an electric compressor, an evaporator, an electric compressor rotation speed controlling unit, a controlling unit and a refrigerant pressure detecting unit. The controlling unit calculates a first candidate for a rotation speed upper limit value of the electric compressor based on a vehicle speed detected by the vehicle speed detecting unit, calculates a second candidate for the rotation speed upper limit value of the electric compressor based on a refrigerant pressure detected by the refrigerant pressure detecting unit, and decides a minimum value of the first and second candidates for the rotation speed upper limit value of the electric compressor, as the rotation speed upper limit value of the electric compressor.

### TECHNICAL FIELD

This invention relates to an air conditioner for vehicle, more particularly, to a vehicle air conditioner that is mounted on a vehicle such as a hybrid vehicle (also called “HEV”) or an electric vehicle (also called “EV”) and that does not give an uncomfortable feeling to a passenger due to noise of its electric compressor and realizes a reduction in power consumption by limiting the rotation of the electric compressor to low when in a proper state.

### BACKGROUND ART

Vehicles such as an electric vehicle and a hybrid vehicle are free of noise generated due to the driving of an engine or are capable of running without such a noise.

Because of this, noise when the electric compressor operates while the vehicle is in a low running speed range or is stopping sometimes gives an uncomfortable feeling to a passenger.

### CITATION LIST

### Patent Literature

Patent Literature 1: Japanese Laid-open Patent Publication No. 04-169322

Patent Literature 2: Japanese Laid-open Patent Publication No. 07-223428

### SUMMARY OF INVENTION

### Technical Problem

In a conventional air conditioner for vehicle, there has been considered a measure for limiting a rotation speed of an electric compressor to a predetermined rotation speed or lower depending on a speed of the vehicle. In this case, since the limited rotation speed of the electric compressor is decided regardless of how well the air conditioning is working, there is an inconvenience that in a state where the air conditioning is fully working, even though the limited rotation speed of the electric compressor can be lowered, the electric compressor wastefully operates to increase power consumption.

Further, if a refrigerant pressure in an air conditioning system becomes high in such a case when a cooling load is very high due to a high outside air temperature or a large amount of solar radiation, heat exchange efficiency of the air conditioning system lowers and consequently, cooling performance does not improve even if the electric compressor is operated at a high rotation speed. Even if the rotation speed of the electric compressor is increased under such a situation, it is not possible to enhance the cooling performance, which poses a problem that power is wastefully consumed.

It is an object of this invention to eliminate an uncomfortable feeling that noise of an electric compressor gives to a passenger and to reduce power consumption by properly limiting the rotation of the electric compressor to low.

### Solution to Problem

Therefore, in order to solve the aforesaid problem, this invention is an air conditioner for a vehicle equipped with a motor for driving the vehicle, the air conditioner including: a vehicle speed detecting unit which detects a speed of the vehicle; an electric compressor and an evaporator which are used for cooling an interior of the vehicle; an electric compressor rotation speed controlling unit which controls a rotation speed of the electric compressor; a controlling unit which sets an upper limit value of the rotation speed of the electric compressor controlled by the electric compressor rotation speed controlling unit, when the vehicle speed detected by the vehicle speed detecting unit is equal to or lower than a predetermined speed; and a refrigerant pressure detecting unit which detects a pressure of a refrigerant flowing in a pipe connecting the electric compressor and the evaporator, wherein the controlling unit calculates a first candidate for the rotation speed upper limit value of the electric compressor based on the vehicle speed detected by the vehicle speed detecting unit, calculates a second candidate for the rotation speed upper limit value of the electric compressor based on the refrigerant pressure detected by the refrigerant pressure detecting unit, and decides a minimum value of the first and second candidates for the rotation speed upper limit value of the electric compressor, as the rotation speed upper limit value of the electric compressor.

### Advantageous Effects of Invention

According to the present invention, it is possible to prevent a passenger from being given an uncomfortable feeling due to noise of an electric compressor. Further, in the present invention, when even an increase in the rotation speed of the electric compressor does not increase cooling performance because a refrigerant pressure in an air conditioning system has become high, the rotation of the electric compressor is limited to low, which can reduce power consumption.

### BRIEF DESCRIPTION OF DRAWINGS

FIG. 1 is a control flowchart for deciding a rotation speed of an electric compressor of an air conditioner for vehicle, showing an example of this invention (example).

FIG. 2 is a system diagram of the air conditioner for vehicle (example).

FIG. 3 is a schematic diagram of a first candidate for a rotation speed upper limit value of the electric compressor based on a vehicle speed (example).

FIG. 4 is a calculation map of the first candidate value for the rotation speed upper limit value of the electric compressor based on the vehicle speed (example).

FIG. 5 is a schematic diagram of a second candidate for the rotation speed upper limit value of the electric compressor based on a refrigerant pressure (example).

FIG. 6 is a chart of a calculation map of the second candidate value for the rotation speed upper limit value of the electric compressor based on the refrigerant pressure (example).

FIG. 7 is a schematic diagram of a calculation method for deciding the rotation speed of the electric compressor (example).

FIG. 8 is a control flowchart for calculating the first candidate value for the rotation speed upper limit value of the electric compressor based on the vehicle speed (example).

FIG. 9 is a control flowchart for calculating the second candidate value for the rotation speed upper limit value of the electric compressor based on the refrigerant pressure (example).

### DESCRIPTION OF EMBODIMENTS

Hereinafter, an example of this invention will be described in detail based on the drawings.

### EXAMPLE

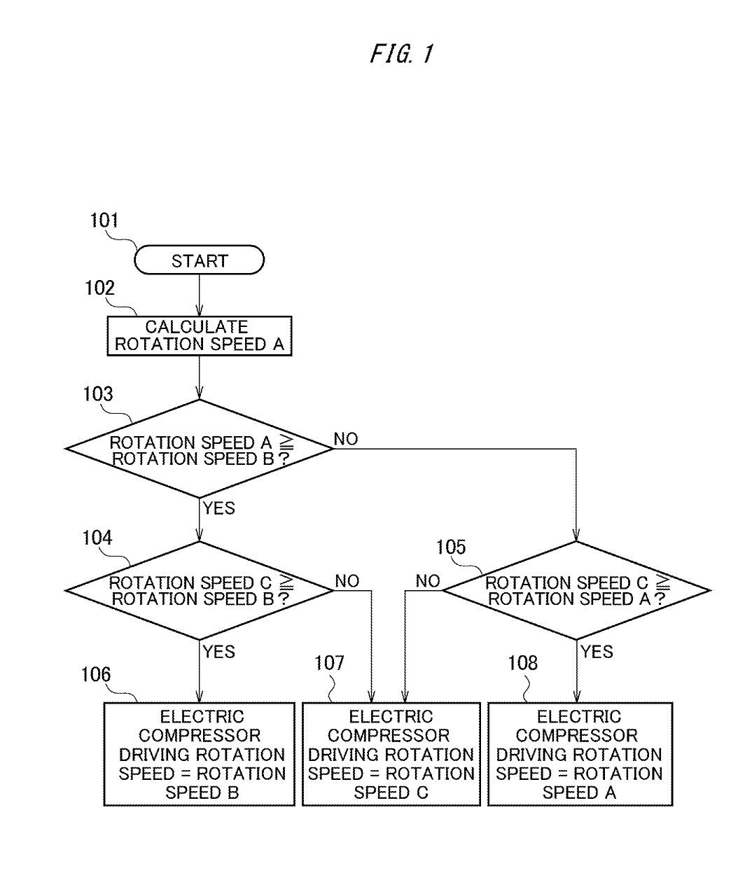

FIG. 1 to FIG. 9 show an example of this invention.

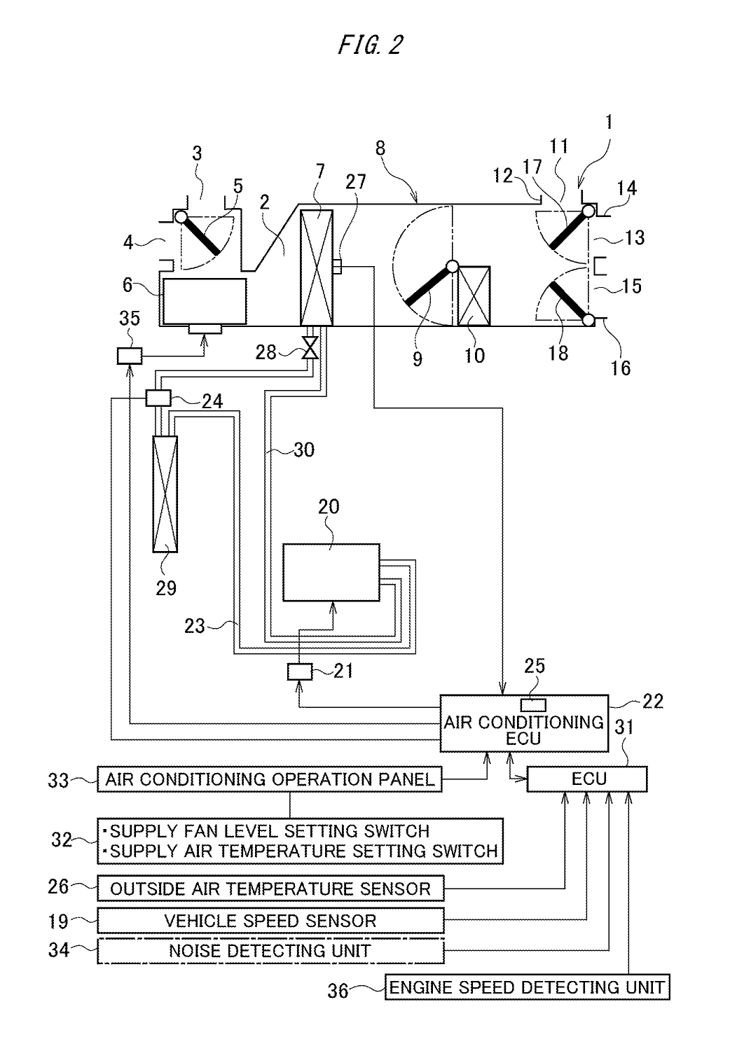

In FIG. 2, 1 denotes an air conditioner for vehicle.

As shown in FIG. 2, the air conditioner 1 for vehicle has an outside air inlet 3 and an inside air inlet 4 on an upstream side of an air conditioning passage 2, and an inside-outside air switching door 5 switches between these outside air inlet 3 and inside air inlet 4.

A supply fan 6 is disposed on a downstream side of the inside-outside air switching door 5, and air is supplied to a downstream side of the air conditioning passage 2 by the supply fan 6.

Further, in the air conditioning passage 2, an evaporator 7 is disposed more downstream than the supply fan 6. More downstream than the evaporator 7, a HVAC unit 8 for heating and cooling air conditioning is disposed.

The HVAC unit 8 includes an air mix door 9 which switches the air conditioning passage 2 between that for cooling and that for heating. In a portion used for heating, a heater core 10 is disposed.

Further, in the air conditioning passage 2, a defroster duct 12 forming a defroster blowout port 11, a vent duct 14 forming a vent blowout port 13, and a foot duct 16 forming a foot blowout port 15 are provided more downstream than the HVAC unit 8.

A first blowout port switching door 17 which switches between the defroster blowout port 11 of the defroster duct 12 and the vent blowout port 13 of the vent duct 14 is provided, and in addition, a second blowout port switching door 18 which opens and closes the foot blowout port 15 of the foot duct 16 is provided.

The air conditioner 1 for vehicle is an air conditioner for a vehicle equipped with a motor (not shown) which drives the vehicle (not shown), and includes a vehicle speed detecting unit 19 being a vehicle sensor which detects a vehicle speed, an electric compressor 20 used for cooling the interior of the vehicle, an electric compressor rotation speed controlling unit 21 which controls a rotation speed of the electric compressor 20, and a controlling unit (also called “air conditioning ECU”) 22 which sets an upper limit value of the rotation speed of the electric compressor 20 controlled by the electric compressor rotation speed controlling unit 21, when the vehicle speed detected by the vehicle speed detecting unit 19 is equal to or lower than a predetermined speed.

The air conditioner 1 for vehicle further includes a refrigerant pressure detecting unit 24 which detects a pressure of a refrigerant flowing in a high-pressure refrigerant pipe 23, a fan air supply amount setting unit 25 which sets an air supply amount by the supply fan 6, an outside air temperature detecting unit 26 which detects an outside air temperature, and an evaporator temperature detecting unit 27 which detects an evaporator temperature. The controlling unit 22 calculates a first candidate Nm1 for the rotation speed upper limit value of the electric compressor 20 based on the vehicle speed detected by the vehicle speed detecting unit 19, and calculates a second candidate Nm2 for the rotation speed upper limit value of the electric compressor 20 based on the refrigerant pressure detected by the refrigerant pressure detecting unit 24. Then, it calculates a candidate Nm3 for a rotation speed of the electric compressor 20 that is necessary for air-conditioning the interior of the vehicle, based on at least one of the air supply amount set by the fan air supply amount setting unit 25, the outside air temperature detected by the outside air temperature detecting unit 26, and the evaporator temperature detected by the evaporator temperature detecting unit 27, and as a rotation speed Nm of the electric compressor 20, decides the minimum value among the first and second candidates Nm1, Nm2 for the rotation speed upper limit value of the electric compressor and the candidate Nm3 for the rotation speed of the electric compressor.

To be in more detail, as shown in FIG. 2, the electric compressor 20 is connected to the evaporator 7 by the high-pressure refrigerant pipe 23, and in the high-pressure refrigerant pipe 23, an expansion valve 28 near the evaporator 7, the refrigerant pressure detecting unit 24 being a refrigerant pressure sensor, and a condenser 29 are disposed in order from the evaporator 7 side.

Further, the electric compressor 20 is connected to the evaporator 7 also by a low-pressure refrigerant pipe 30 besides by the aforesaid high-pressure refrigerant pipe 23.

Further, a fan rotation speed controlling unit 35 which controls a rotation speed of the supply fan 6 is connected to the supply fan 6. Furthermore, a vehicle controlling unit (also called “ECU” or “controller”) 31 is connected to the controlling unit 22. To the vehicle controlling unit 31, the vehicle speed detecting unit 19, the outside air temperature detecting unit 26 being an outside air temperature sensor, and when the vehicle is a hybrid vehicle (HEV), an engine speed detecting unit 36 which detects a rotation speed of an engine are connected. The controlling unit 22 obtains the vehicle speed, the outside air temperature, and so on from the vehicle controlling unit 31.

The controlling unit 22 includes the fan air supply amount setting unit 25 which sets the air supply amount by the supply fan 6. Further, to the controlling unit 22, there are connected the refrigerant pressure detecting unit 24, the evaporator temperature detecting unit 27 disposed on the evaporator 7, the electric compressor rotation speed controlling unit 21 linked to the electric compressor 20, and an air conditioning operation panel 33 to which a supply fan level setting switch and a supply air temperature setting switch 32 are connected.

Incidentally, in this example, a manual air conditioner whose air conditioning operation panel 33 having the supply fan level setting switch and the supply air temperature setting switch 32 is operated by a user himself/herself is described, but the manual air conditioner can be replaced by an auto air conditioner.

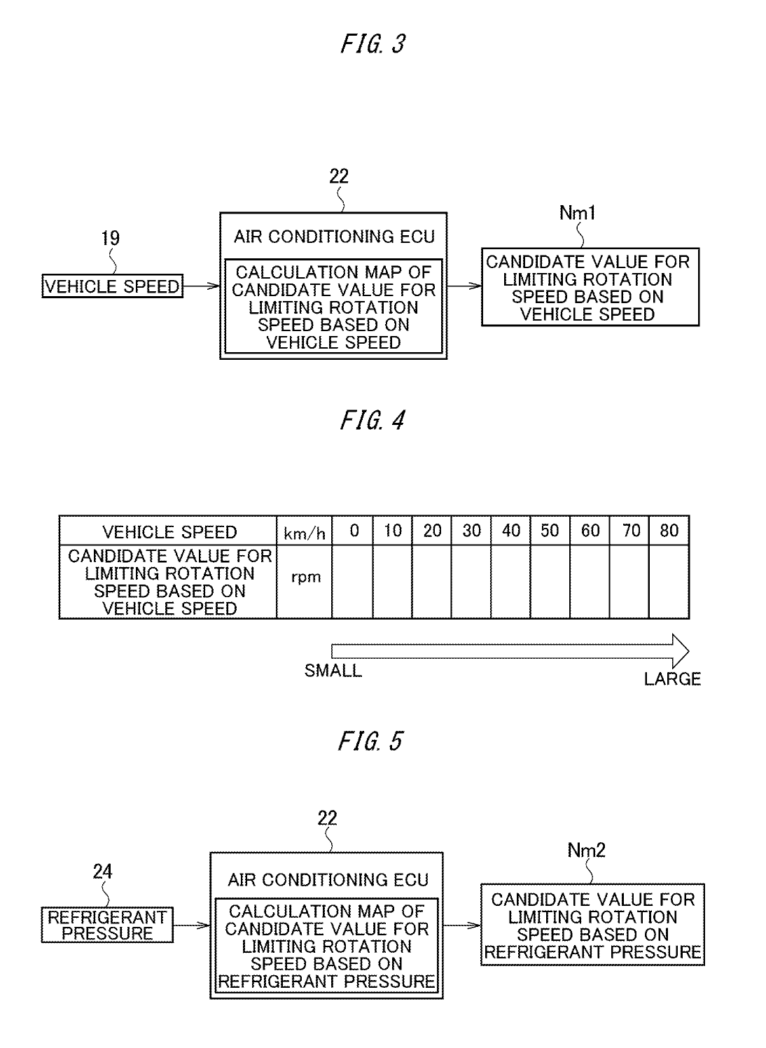

At this time, the controlling unit 22 calculates the first candidate Nm1 for the rotation speed upper limit value of the electric compressor 20 based on the vehicle speed detected by the vehicle speed detecting unit 19 as shown in FIG. 3.

Note that the controlling unit 22 uses a calculation map of a candidate value for limiting the rotation speed based on the vehicle speed as shown in FIG. 4 when calculating the first candidate Nm1 for the rotation speed upper limit value of the electric compressor 20.

Further, the controlling unit 22 calculates the second candidate Nm2 for the rotation speed upper limit value of the electric compressor 20 based on the refrigerant pressure detected by the refrigerant pressure detecting unit 24 as shown in FIG. 5.

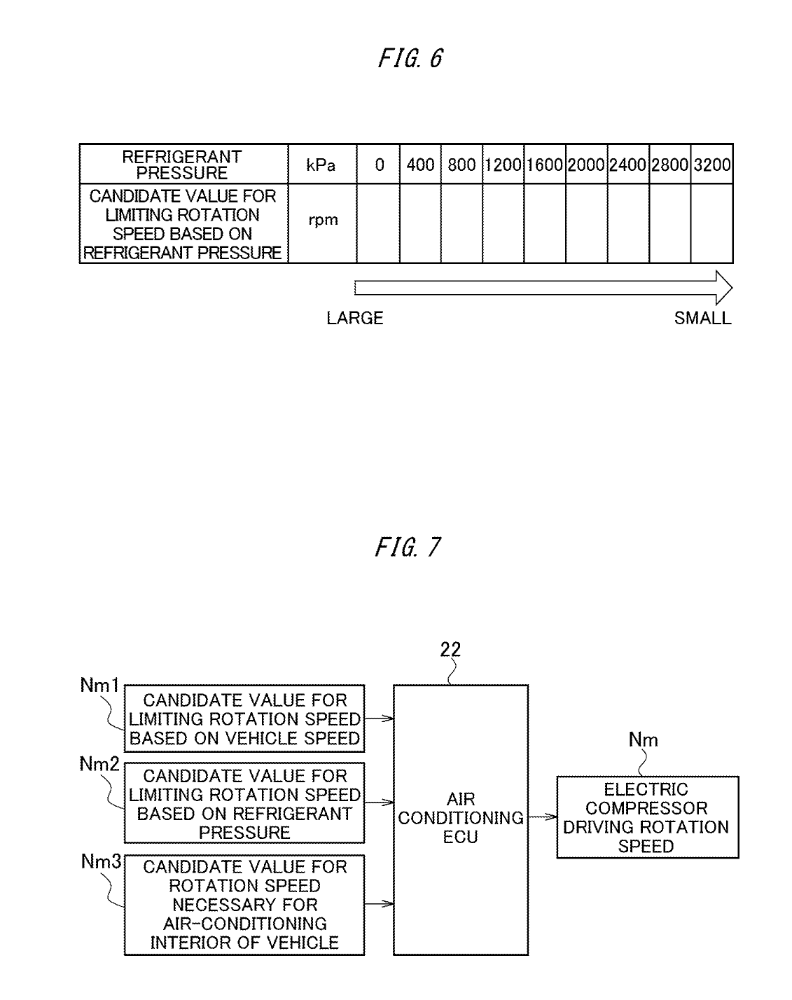

Note that the controlling unit 22 uses a calculation map of a candidate value for limiting the rotation speed based on the refrigerant pressure as shown in FIG. 6 when calculating the second candidate Nm2 for the rotation speed upper limit value of the electric compressor 20.

Further, the controlling unit 22 calculates the candidate Nm3 for the rotation speed of the electric compressor 20 necessary for air-conditioning the interior of the vehicle based on at least one of the air supply amount set by the fan air supply amount setting unit 25, the outside air temperature detected by the outside air temperature detecting unit 26, and the evaporator temperature detected by the evaporator temperature detecting unit 27. The candidate Nm3 for the rotation speed of the electric compressor 20 is the rotation speed necessary to satisfy air conditioning performance making the interior of the vehicle comfortable.

Then, as the rotation speed Nm of the electric compressor 20, the controlling unit 22 decides the minimum value among the first and second candidates Nm1, Nm2 for the rotation speed upper limit value of the electric compressor and the candidate Nm3 for the rotation speed of the electric compressor as shown in FIG. 7.

Therefore, in order not to give an uncomfortable feeling to a passenger due to noise of the electric compressor 20 and when even an increase in the rotation speed of the electric compressor 20 does not increase cooling performance because the refrigerant pressure in the air conditioning system has become high, the rotation of the electric compressor 20 is limited to low, which can reduce power consumption.

Incidentally, the above-described method of calculating the candidate Nm3 for the rotation speed of the electric compressor 20 necessary for air-conditioning the interior of the vehicle can be a method not only to calculate it based on at least one of the air supply amount set by the fan air supply amount setting unit 25, the outside air temperature detected by the outside air temperature detecting unit 26, and the evaporator temperature detected by the evaporator temperature detecting unit 27, but also to take it into consideration how the user himself/herself operates the air conditioning operation panel 33 having the supply fan level setting switch and the supply air temperature setting switch 32.

Another possible structure is that a noise detecting unit 34 which detects a level of noise is provided as shown by the dashed line in FIG. 2, and the controlling unit 22 calculates the first candidate Nm1 for the rotation speed upper limit value of the electric compressor 20 based on the level of the noise detected by the noise detecting unit 34 instead of the vehicle speed detected by the vehicle speed detecting unit 19.

Therefore, noise irrelevant to a running state can also be detected, which enables the control according to the current state.

For example, when noise around the vehicle is small even during high-speed driving, the rotation speed of the electric compressor 20 is limited to low, which makes it possible to prevent an uncomfortable feeling due to the electric compressor 20 from being given to the passenger.

Next, the operation will be described.

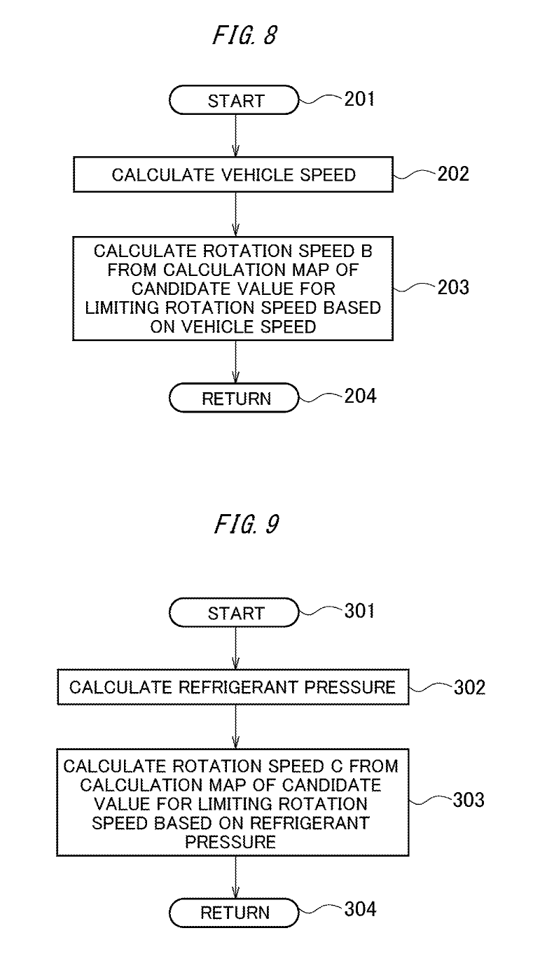

First, a description will be given along a control flowchart in FIG. 8 for calculating the first candidate value for the rotation speed upper limit value of the electric compressor based on the vehicle speed.

When a control program for calculating the first candidate value for the rotation speed upper limit value of the electric compressor based on the vehicle speed starts (201), the controlling unit 22 receives a detection signal of the vehicle speed detected by the vehicle speed detecting unit 19 to shift to a process (202) for calculating the vehicle speed.

Then, after this process (202), it shifts to a process (203) for calculating the first candidate Nm1 for the rotation speed upper limit value of the electric compressor 20 being a rotation speed B from the calculation map, in FIG. 4, of the candidate value for limiting the rotation speed based on the vehicle speed, and thereafter shifts to RETURN (204).

Further, a description will be given along a control flowchart in FIG. 9 for calculating the second candidate value for the rotation speed upper limit value of the electric compressor based on the refrigerant pressure.

When a control program for calculating the second candidate value for the rotation speed upper limit value of the electric compressor based on the refrigerant pressure starts (301), the controlling unit 22 receives a detection signal of the refrigerant pressure detected by the refrigerant pressure detecting unit 24 to shift to a process (302) for calculating the refrigerant pressure.

Then, after this process (302), the controlling unit 22 shifts to a process (303) for calculating the second candidate Nm2 for the rotation speed upper limit value of the electric compressor 20 being a rotation speed C, from the calculation map, in FIG. 6, of the candidate value for the rotation speed upper limit value based on the refrigerant pressure, and thereafter shifts to RETURN (304).

Further, a description will be given along a control flowchart in FIG. 1 for deciding the rotation speed upper limit value of the electric compressor 20 of the air conditioner 1 for vehicle.

Note that the “rotation speed A” in FIG. 1 is the “candidate value for the rotation speed necessary for air-conditioning the interior of the vehicle”. The “rotation speed B” is the “candidate value for limiting the rotation speed based on the vehicle speed (=the first candidate for the rotation speed upper limit value of the electric compressor)”. The “rotation speed C” is the “candidate value for limiting the rotation speed based on the refrigerant pressure (=the second candidate for the rotation speed upper limit value of the electric compressor). Further, the “electric compressor driving rotation speed” in FIG. 1 is a “rotation speed for driving the electric compressor”.

When a control program for deciding the rotation speed upper limit value of the electric compressor 20 of the air conditioner 1 for vehicle starts (101), the controlling unit 22 shifts to a process (102) for calculating the candidate Nm3 for the rotation speed of the electric compressor 20 necessary for air-conditioning the interior of the vehicle being the rotation speed A.

In this process (102), the controlling unit 22 calculates the candidate Nm3 for the rotation speed of the electric compressor 20 necessary for air-conditioning the interior of the vehicle based on at least one of the air supply amount set by the fan air supply amount setting unit 25, the outside air temperature detected by the outside air temperature detecting unit 26, and the evaporator temperature detected by the evaporator temperature detecting unit 27.

Then, after this process (102), the controlling unit 22 shifts to a determination (103) on whether or not the candidate Nm3 for the rotation speed of the electric compressor 20 necessary for air-conditioning the interior of the vehicle being the rotation speed A is equal to or more than the first candidate Nm1 for the rotation speed upper limit value of the electric compressor 20 being the rotation speed B, that is, whether or not Nm3≧Nm1.

In this determination (103), when the determination (103) is YES, the controlling unit 22 shifts to a determination (104) on whether or not the second candidate Nm2 for the rotation speed upper limit value of the electric compressor 20 being the rotation speed C is equal to or more than the first candidate Nm1 for the rotation speed upper limit value of the electric compressor 20 being the rotation speed B, that is, whether or not Nm2≧Nm1.

On the other hand, when the determination (103) is NO, the controlling unit 22 shifts to a determination (105) on whether or not the second candidate Nm2 for the rotation speed upper limit value of the electric compressor 20 being the rotation speed C is equal to or more than the candidate Nm3 for the rotation speed of the electric compressor 20 necessary for air-conditioning the interior of the vehicle being the rotation speed A, that is, whether or not Nm2≧Nm3.

In the above determination (104) on whether or not the second candidate Nm2 for the rotation speed upper limit value of the electric compressor 20 being the rotation speed C is equal to or more than the first candidate Nm1 for the rotation speed upper limit value of the electric compressor 20, that is, whether or not Nm2≧Nm1, when the determination (104) is YES, the controlling unit 22 shifts to a process (106) for deciding the first candidate Nm1 for the rotation speed upper limit value of the electric compressor 20 being the rotation speed B which is the minimum value, as the aforesaid rotation speed upper limit value Nm of the electric compressor 20.

On the other hand, when the determination (104) is NO, the controlling unit 22 shifts to a process (107) for deciding the second candidate Nm2 for the rotation speed upper limit value of the electric compressor 20 being the rotation speed C which is the minimum value, as the aforesaid rotation speed upper limit value Nm of the electric compressor 20.

Further, in the above determination (105) on whether or not the second candidate Nm2 for the rotation speed upper limit value of the electric compressor 20 being the rotation speed C is equal to or more than the candidate Nm3 for the rotation speed of the electric compressor 20 necessary for air-conditioning the interior of the vehicle being the rotation speed A, that is, whether or not Nm2≧Nm3, when the determination (105) is YES, the controlling unit 22 shifts to a process (108) for deciding the candidate Nm3 for the rotation speed of the electric compressor 20 necessary for air-conditioning the interior of the vehicle being the rotation speed A which is the minimum value, as the aforesaid rotation speed upper limit value Nm of the electric compressor 20.

On the other hand, when the determination (105) is NO, the controlling unit 22 shifts to a process (107) for deciding the second candidate Nm2 for the rotation speed upper limit value of the electric compressor 20 being the rotation speed C which is the minimum value, as the aforesaid rotation speed upper limit value Nm of the electric compressor 20.

It should be noted that this invention is not limited to the above-described example and various applications and modifications are possible.

For example, in the example of this invention, the structure in which the calculation of the first candidate for the rotation speed upper limit value of the electric compressor is based on the vehicle speed detected by the vehicle speed detecting unit and the structure in which it is based on the level of the noise detected by the noise detecting unit are disclosed, but if in a hybrid vehicle, a special structure is also possible in which the first candidate for the rotation speed upper limit value of the electric compressor is calculated based on a value of the engine speed detected by an engine speed detecting unit 36.

In the foregoing, the embodiment and the examples of the present invention are described in detail with reference to the drawings, but the present invention is by no means limited to the embodiment and the examples. The present invention can be variously changed within a range not departing from its spirit.

### INDUSTRIAL APPLICABILITY

According to the present invention, it is possible to prevent a passenger from being given an uncomfortable feeling due to noise of an electric compressor. Moreover, in the present invention, when even an increase in the rotation speed of the electric compressor does not increase cooling performance because a refrigerant pressure in an air conditioning system has become high, the rotation of the electric compressor is limited to low, which can reduce power consumption.

### REFERENCE SIGNS LIST

1 air conditioner for vehicle

2 air conditioning passage

3 outside air inlet

4 inside air inlet

5 inside-outside air switching door

6 supply fan

7 evaporator

8 HVAC unit

10 heater core

11 defroster blowout port

13 vent blowout port

15 foot blowout port

17 first blowout port switching door

18 second blowout port switching door

19 vehicle speed detecting unit

20 electric compressor

21 electric compressor rotation speed controlling unit

22 controlling unit (also called “air conditioning ECU”)

23 high-pressure refrigerant pipe

24 refrigerant pressure detecting unit

25 fan air supply amount setting unit

26 outside air temperature detecting unit

27 evaporator temperature detecting unit

30 low-pressure refrigerant pipe

31 vehicle controlling unit (also called “ECU” or “controller”)

33 air conditioning operation panel

34 noise detecting unit

1. An air conditioner for a vehicle equipped with a motor for driving the vehicle, the air conditioner comprising:
a vehicle speed detecting unit which detects a speed of the vehicle;
an electric compressor and an evaporator which are used for cooling an interior of the vehicle;
an electric compressor rotation speed controlling unit which controls a rotation speed of the electric compressor;
a controlling unit which sets an upper limit value of the rotation speed of the electric compressor controlled by the electric compressor rotation speed controlling unit, when the vehicle speed detected by the vehicle speed detecting unit is equal to or lower than a predetermined speed; and
a refrigerant pressure detecting unit which detects a pressure of a refrigerant flowing in a pipe connecting the electric compressor and the evaporator, wherein
the controlling unit calculates a first candidate for the rotation speed upper limit value of the electric compressor based on the vehicle speed detected by the vehicle speed detecting unit, calculates a second candidate for the rotation speed upper limit value of the electric compressor based on the refrigerant pressure detected by the refrigerant pressure detecting unit, and decides a minimum value of the first and second candidates for the rotation speed upper limit value of the electric compressor, as the rotation speed upper limit value of the electric compressor.
